(19) United States
(12) Patent Application Publication
(10) Pub. No.: US 2026/0254388 A1
(43) Pub. Date: Aug. 27, 2026

(54) SYSTEMS AND METHODS FOR ADAPTIVE DIRECT CURRENT BUS VOLTAGE USING A FIXED MODULATION INDEX FOR PERMANENT SYNCHRONOUS MAGNET DRIVES

(71) Applicant: STEERING SOLUTIONS IP HOLDING CORPORATION, Saginaw, MI (US)

(72) Inventors: Payam RAMEZANI-BADR, Saginaw, MI (US); Krishna NAMBURI, Troy, MI (US); Vignesh Kumar Ramamurthy Chandra MOULI, Saginaw, MI (US)

(21) Appl. No.: 19/061,570

(22) Filed: Feb. 24, 2025

(51) Int. Cl. H02P 25/022; B62D 5/00; B62D 5/04; H02P 23/00

(52) U.S. Cl. CPC H02P 25/022; B62D 5/006; B62D 5/046; H02P 23/0022

(57) ABSTRACT

A method includes setting, for a motor, a modulation index to a predetermined value. The method also includes calculating a bridge voltage for an output voltage command based on the predetermined value of the modulation index, and selectively controlling the motor based on the bridge voltage.

### TECHNICAL FIELD

This disclosure related to steering systems, and, in particular, to systems and methods for adaptive direct current bus voltage using a fixed modulation index for permanent synchronous magnet drives.

### BACKGROUND

Vehicles, such as cars, trucks, sport utility vehicles, crossovers, mini-vans, marine craft, aircraft, all-terrain vehicles, recreational vehicles, or other suitable vehicles, include a steering system, such as an electronic power steering (EPS) system, a steer-by-wire (SbW) steering system, a hydraulic steering system, or other suitable steering system. The steering system typically includes one or more controllers that control various aspects of the steering system including, but not limited to, controlling one or more electric motors and/or one or more actuators of the steering system.

### SUMMARY

This disclosure relates generally to steering systems.

An aspect of the disclosed embodiments includes a method that includes setting, for a motor, a modulation index to a predetermined value. The method also includes calculating a bridge voltage for an output voltage command based on the predetermined value of the modulation index, and selectively controlling the motor based on the bridge voltage.

Another aspect of the disclosed embodiments includes a system that includes a controller configured to: set, for a motor, a modulation index to a predetermined value; calculate a bridge voltage for an output voltage command based on the predetermined value of the modulation index; and selectively control the motor based on the bridge voltage.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIGS. 3A-3D generally illustrate a system for adaptive direct current bus voltage using a fixed modulation index for permanent synchronous magnet drives, according to the principles of the present disclosure.

FIG. 4 is a flow diagram generally illustrating a method for adaptive direct current bus voltage using a fixed modulation index for permanent synchronous magnet drives, according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, vehicles, such as cars, trucks, sport utility vehicles, crossovers, mini-vans, marine craft, aircraft, all-terrain vehicles, recreational vehicles, or other suitable vehicles, include a steering system, such as an EPS system, a SbW steering system, a hydraulic steering system, or other suitable steering system. The steering system typically includes one or more controllers that control various aspects of the steering system including, but not limited to, controlling one or more electric motors and/or one or more actuators of the steering system.

The one or more electric motors of the steering system may include a permanent magnet synchronous motor (PMSM) drive. In such drives, a direct current (DC) voltage determines the amount of power, torque, and/or energy “capacity” that is available in the drive. A voltage source inverter can modulate any voltage between 0 to V_{DC} line-line

$$( \frac{{V}_{DC}}{\sqrt{3}} phase )$$

peak magnitude by varying the modulation index:

$$m = \frac{\sqrt{3} {V}_{m}^{*}}{{V}_{DC}} \qquad ( 1 a )$$

$${V}_{m}^{*} = \sqrt{{V}_{d}^{* 2} + {V}_{q}^{* 2}} \qquad ( 1 b )$$

Where

$${V}_{d}^{*} and {V}_{q}^{*}$$

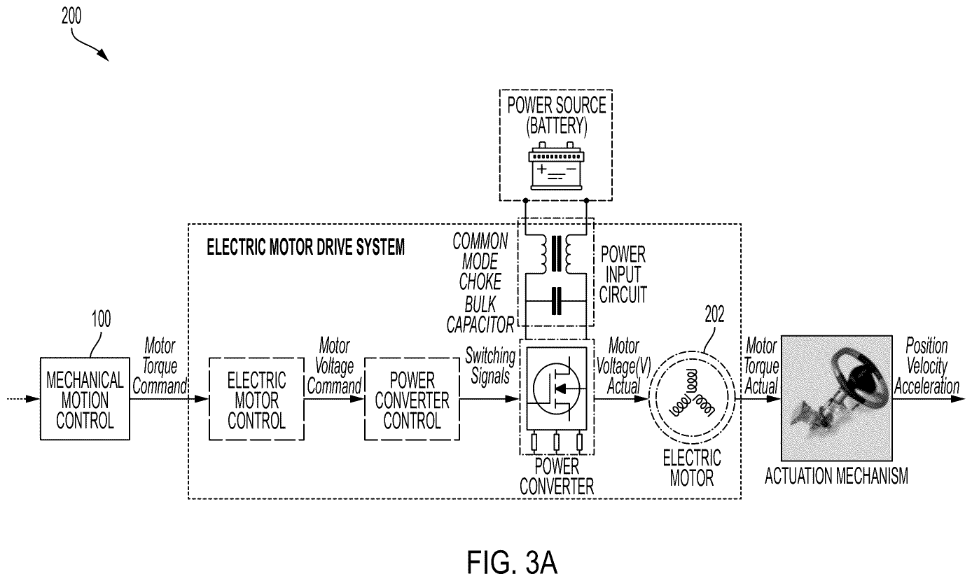

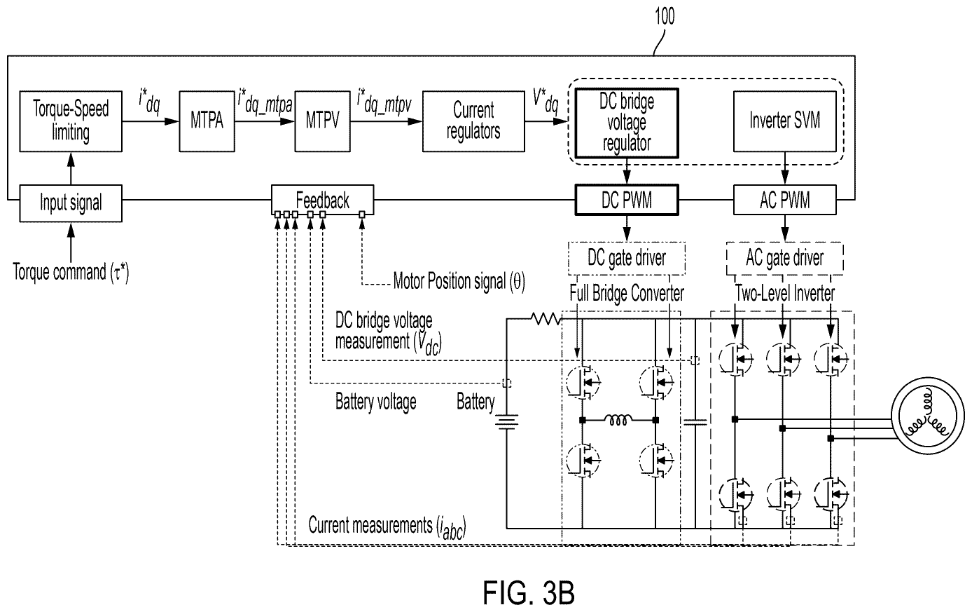

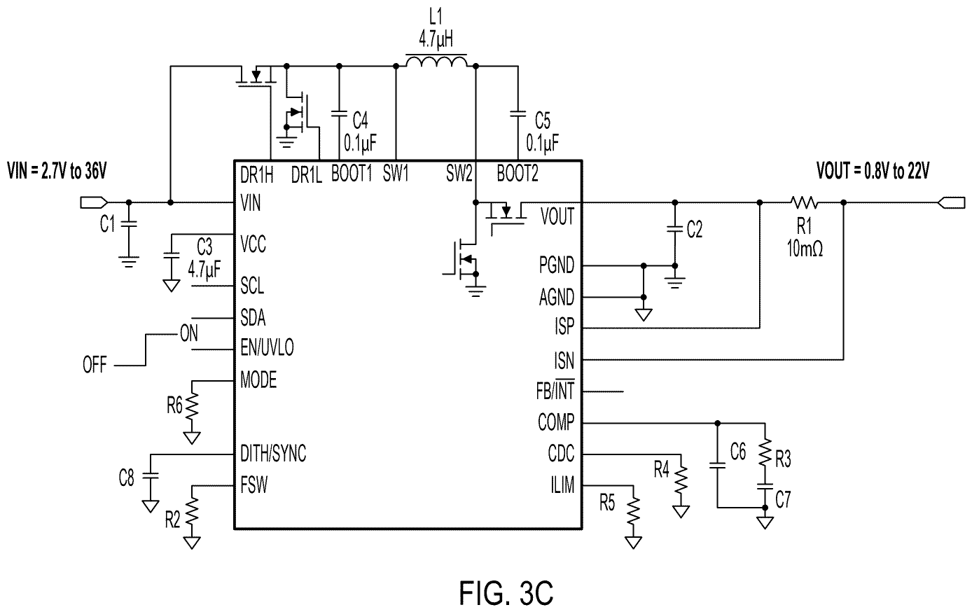

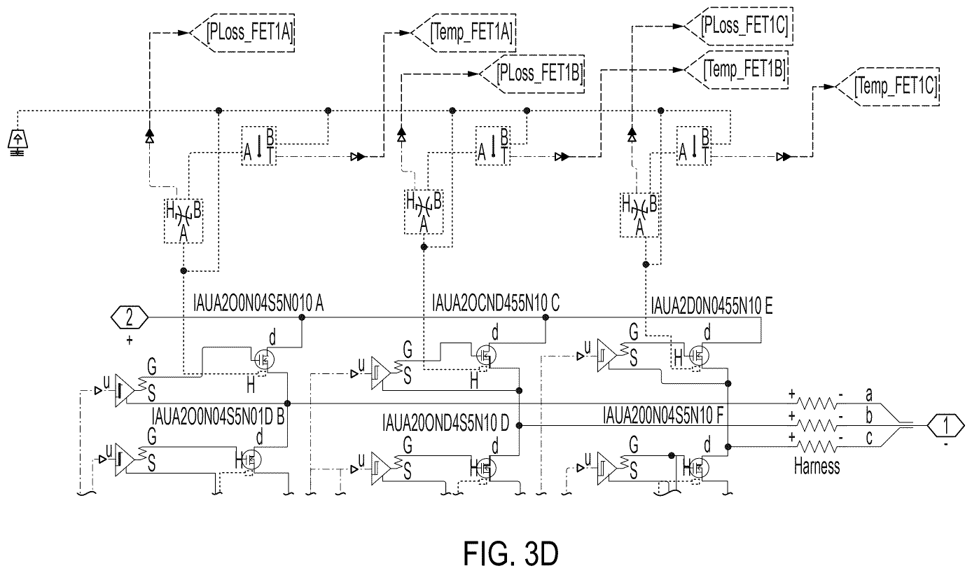

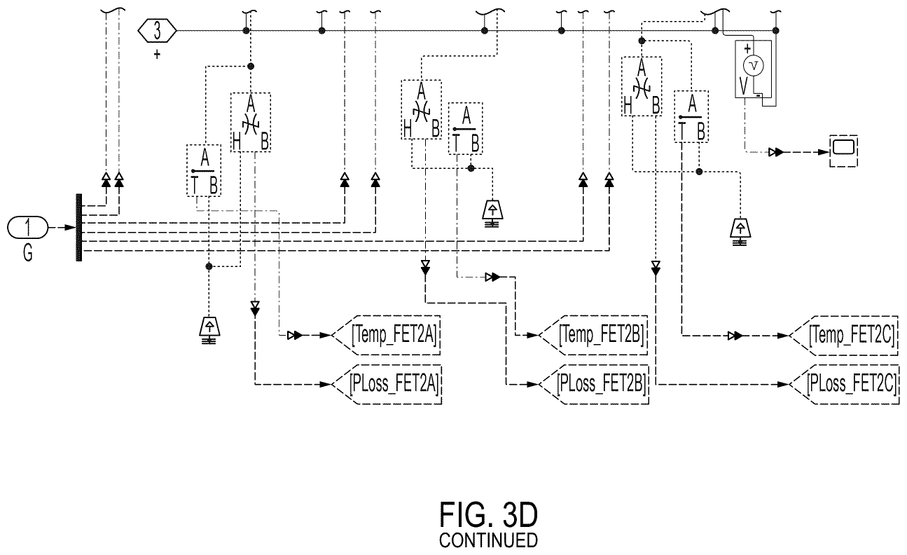

are the inverter phase voltage commands, in d-axis and q-axis synchronous reference frame, respectively. Depending on the load torque command and the measured rotational speed, the nominal battery voltage may not be needed or more voltage than the nominal voltage may be needed to meet demand. The nominal battery voltage can be 12 V, 48 V, 400 V, etc. depending on the application. This fact is significant in applications that have widely variable speed ranges, or the motor is mostly stationary or at low-speed. Typically, powerpacks for an EPS steering system includes power inverters, electric motors, and measurement sensors such as position, current, and voltage. As shown in FIG. 3A, the powerpack is directly connected to the vehicle battery using a harness, then filtered with passive circuits to mitigate voltage ripples before the DC terminals of the inverter. The DC bridge voltage of the inverter is one of the primary factors that determines the torque and/or power production capacity available to the powerpack, and the controller utilizes this capacity to meet operational requirements, like torque command, supply current limit, and regenerative current limits. The ultimate objective is to accurately and reliably provide the requested torque command of the electronic control unit (ECU), and one of the limiting factors in achieving this objective is the DC bridge voltage. A powerpack controller algorithm typically measures the bridge voltage and uses it to limit torque production at the power management stage of motor control. For example, for a PMSM motor parameter of Nₚ (number of poles), Kₑ (back-emf constant), Rₛ (motor resistance [ohms]), L_{d} (d-axis synchronous inductance [H]), and L_{q} (q-axis synchronous inductance [H]); the steady-state peak torque (T) capability for a given DC bridge voltage is given by the voltage constraint in Eq (2a).

$${( {R}_{s} {I}_{d} + {ω}_{e} {L}_{q} {I}_{q} )}^{2} + {( {R}_{s} {I}_{q} + {K}_{e} {ω}_{m} - {ω}_{e} {L}_{d} {I}_{d} )}^{2} = \frac{{V}_{DC}^{2}}{3} \qquad ( 2 a )$$

$$T = \frac{3}{2} {K}_{e} {I}_{q} + \frac{3}{4} {N}_{p} ( {L}_{q} - {L}_{d} ) {I}_{d} {I}_{q} \qquad ( 2 b )$$

Where ωₑ and ωₘ are the electrical and mechanical speed in radians-per-second, respectively, and I_{d} and I_{q} are the synchronous frame currents. Typically, there are at least two powerpacks per actuator in SbW, the handwheel actuator (HWA) and the roadwheel actuator (RWA). The HWA task is to 1) measure the handwheel rotational angle and send it to the RWA to generate the necessary torque to align the wheels with the driver commanded turn angle, and 2) replicate road conditions by generating a “feel” torque at the handwheel. The “feel” torque is orders of magnitude smaller than the torque the RWA must produce to rotate the vehicle wheels; therefore, HWAs are expected to generate fractional torque commands mostly opposing the driver motion (quadrant 2 and 4). Given that the motor torque capability at a given speed is directly proportional to the bridge voltage, and since HWA motors are expected to operate in stationary and/or low speeds, a case can be made that the full battery voltage is not always necessary to modulate the necessary outputs. Furthermore, different original equipment manufacturers (OEMs) have different torque-speed requirements, which may be accommodated by building different motors, but it is possible to change the speed and power range of identical motors by varying the DC bridge voltage of the powerpack. Additionally, if multi-wound, multi-ECU motors are supplied by multiple batteries, asymmetrical motor iron core saturation may be avoided with an adaptive DC bridge.

Accordingly, systems and methods, such as those described herein, configured to adaptively change the DC bridge voltage of a PMSM drive by fixing the modulation index at a fixed value, may be desirable. In some embodiments, the systems and methods described herein may be configured to adaptively change the DC bridge voltage based on operational needs by fixing the modulation index. Simulation and dynamometer test results show that the systems and methods described herein may reduce a PMSM powerpack output electromagnetic torque ripple and extend operatable speed range. While the systems and methods described herein are described with respect to the special needs of the HWA in SbW programs, thus yielding the best performance advantage in that application, the systems and methods described herein may be applicable to all PMSM-based drive systems.

The systems and methods described herein may be configured to reduce the torque ripple due to the low inductance behavior of printed circuit board (PCB) stator motors. The systems and methods described herein may be configured to improve indirect costs by extending the speed and power range of existing motors or inversely, reduce battery input power for user requirements.

The systems and methods described herein may be configured to provide torque ripple reduction, reducing total harmonic distortion and extending torque envelope range. The mathematical relationship between the average bridge voltage and the output current and voltage ripple may be used to optimally size input passive filters of converters. It must be noted that PMSMs are modeled as resistive-inductive (RL) loads, and Eq. (3a) and (3b) are derived considering a resistive load; therefore, the actual ripple relationships are time-dependent in transient (e.g., discontinuous) conduction mode of inverter switches. However, in steady state, Eq. (3a) and (3b) still apply to RL loads such as PMSMs.

$$Δ {I}_{L , max} = \frac{{V}_{DC , avg}}{8 {f}_{s w} {L}_{DC}} \qquad ( 3 a )$$

$$Δ {V}_{DC , max} = \frac{{V}_{DC , avg}}{16 {f}_{s w}^{2} {L}_{DC} {C}_{b l k}} \qquad ( 3 b )$$

Where f_{sw} is the switching frequency, L_{DC} is the input inductance, and C_{blk} is the inverter bulk capacitor. Eq. (4) shows the modulation index in SVM based inverter control algorithm. By fixing the modulation index at a pre-determined desired value (m*), the systems and methods described herein may be configured to calculate the bridge voltage for any given output voltage command.

$${V}_{DC}^{*} = \frac{\sqrt{3} {V}_{m}^{*}}{{m}^{*}} \qquad ( 4 )$$

Where

$${V}_{m}^{*}$$

is the inverter output voltage command magnitude. Substituting (4) into (2), the systems and methods described herein may be configured to arrive at the control law of (5) for the desired DC bridge voltage using either feedforward (5a) or closed-loop inverter modulation reference voltages (5b).

$${V}_{DC}^{*} = \frac{α \sqrt{3}}{{m}^{*}} \sqrt{{( {R}_{s} {I}_{d}^{*} + {ω}_{e} {L}_{q} {I}_{q}^{*} )}^{2} + {( {R}_{s} {I}_{q}^{*} + {K}_{e} {ω}_{m} - {ω}_{e} {L}_{d} {I}_{d}^{*} )}^{2}} \qquad ( 5 a )$$

$${V}_{DC}^{*} = \frac{α \sqrt{3}}{{m}^{*}} \sqrt{{f}_{d}^{2} ( {I}_{d}^{*} , {I}_{d} ) + {f}_{q}^{2} ( {I}_{q}^{*} , {I}_{q} )} \qquad ( 5 b )$$

$${V}_{DC}^{low} \leq {V}_{DC}^{*} \leq {V}_{DC}^{high} \qquad ( 5 c )$$

Where α is an optional gain factor, and f_{d} and f_{q} are the d-axis and q-axis current regulator functions, respectively. The low and high limit constraints in (5c) are incorporated to implement component voltage safety limits and depend on hardware ratings. The appropriate DC bridge voltage reference, given the requested torque, and rotational speed is calculated in (5), and then generated using a full-bridge converter between the battery and the bulk capacitor as shown in FIGS. 3B-3D. The full-bridge is a buck-boost converter that can increase or decrease the DC bridge voltage with respect to the battery. While the full-bridge converter is described herein, simpler buck or boost half-bridges can be alternatively used.

In some embodiments, the systems and methods described herein may be configured adaptively change the DC bridge voltage of a PMSM drive system by fixing the modulation index at a desired value. The systems and methods described herein may be configured to ensure ensures the modulation index is kept at a constant level from unity and thus not susceptible to saturation from sudden transient changes, or measurement time delays.

The systems and methods described herein may be configured to use a fixed desired modulation index as to allocate an appropriate DC bridge voltage, given the motor's operational requirements at each time-step based on Eq. (5). The systems and methods described herein may be configured to expand upon the previous research on PMSM drives with adaptive DC voltages that provide improved torque harmonic performance and extended speed range while avoiding the transient modulation index saturation issues. The systems and methods described herein may be configured to keep the modulation index unsaturated and regulated to the desired value. The systems and methods described herein may be configured to account for physical voltage limits based on Eq. (5c), even during transient dynamics.

In some embodiments, the systems and methods described herein may be configured to set, for a motor, a modulation index to a predetermined value. The motor may include a permanent magnet synchronous motor or other suitable motor. The motor may be associated with a steering system of a vehicle, such as a SbW steering system or other suitable steering system. In some embodiments, the motor may be associated with a handwheel actuator of the steering system and/or a roadwheel actuator of the steering system. In some embodiments, the modulation index value is configured to control torque harmonic performance of the motor.

The systems and methods described herein may be configured to calculate a DC bridge voltage based on a predetermined value of the modulation index. For example, the systems and methods described herein may be configured to calculate the DC bridge voltage with respect to the outputs of the current regulator that drives the inverter. In some embodiments, the systems and methods described herein may be configured to calculate the DC bridge voltage using feedforward mathematical relationships as described in (5a).

The systems and methods described herein may be configured to selectively control the motor based on the DC bridge voltage. For example, the systems and methods described herein may be configured to selectively control the motor by either increasing or decreasing the DC bridge voltage with respect to the nominal battery voltage, based on operational requirements, at any given time step.

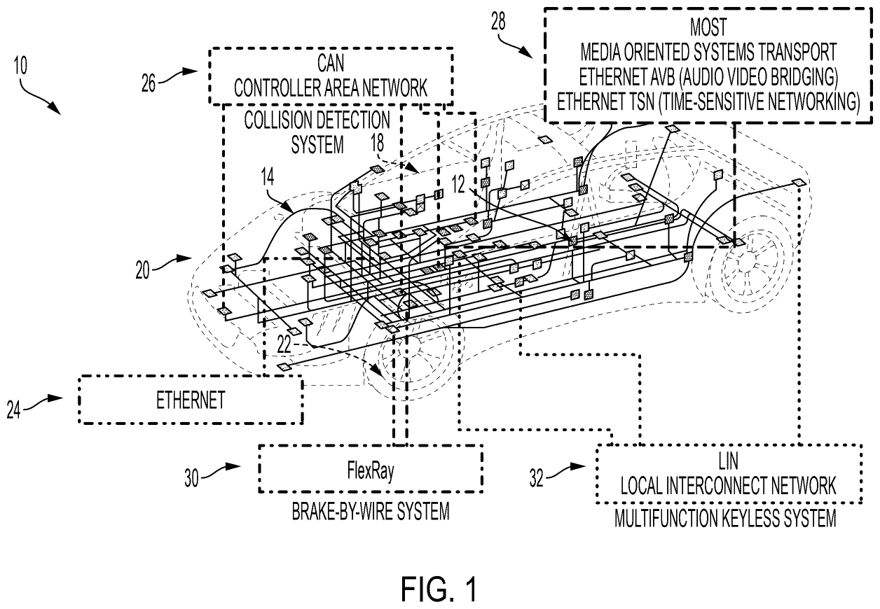

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a steering wheel, and other such components are disposed in the passenger compartment 18 of the vehicle 10. The propulsion controls may be actuated or controlled by a driver of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

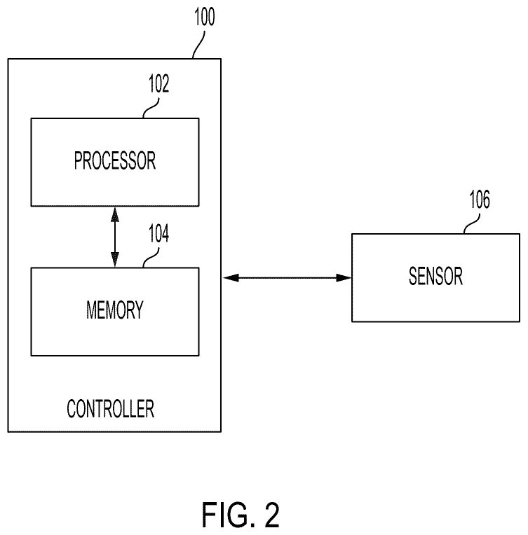

In some embodiments, the steering system may include a steering system controller, such as controller 100, as is generally illustrated in FIG. 2. The controller 100 may include any suitable controller. The controller 100 may be configured to control, for example, the various functions of the steering system. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various functions of the steering system.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angel, a motor velocity, a vehicle speed, other suitable information, or a combination thereof.

In some embodiment, the controller 100 may be configured to set, for a motor, a modulation index to a predetermined value. The motor may include a PMSM or other suitable motor. The motor may be associated with a steering system of the vehicle 10, such as a SbW steering system or other suitable steering system. In some embodiments, the motor may be associated with a handwheel actuator of the steering system and/or a roadwheel actuator of the steering system. In some embodiments, the modulation index value is configured to control torque harmonic performance of the motor.

The controller 100 may calculate a bridge voltage for an output voltage command based on the predetermined value of the modulation index. For example, the controller 100 may calculate the bridge voltage based on inverter feedback regulator output commands. In some embodiments, the controller 100 may calculate the bridge voltage using feedforward motor model equations.

The controller 100 may selectively control the motor based on the bridge voltage. For example, the controller 100 may selectively control the motor based on the bridge voltage either by increasing or decreasing the DC bridge voltage with respect to the nominal input battery voltage

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

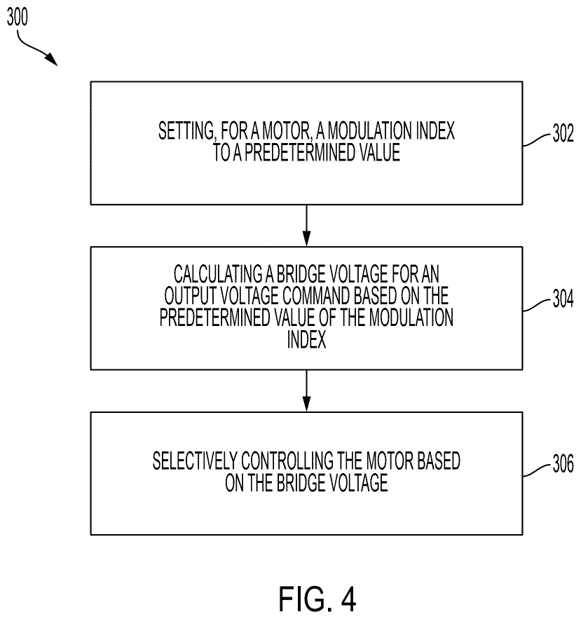

FIG. 4 is a flow diagram generally illustrating a method 300 according to the principles of the present disclosure. At 302, the method 300 sets, for a motor, a modulation index to a predetermined value.

At 304, the method 300 calculates a bridge voltage for an output voltage command based on the predetermined value of the modulation index.

At 306, the method 300 selectively controls the motor based on the bridge voltage

In some embodiments, a method includes setting, for a motor, a modulation index to a predetermined value. The method also includes calculating a bridge voltage for an output voltage command based on the predetermined value of the modulation index, and selectively controlling the motor based on the bridge voltage.

In some embodiments, the motor includes a permanent magnet synchronous motor. In some embodiments, the motor is associated with a steering system of a vehicle. In some embodiments, the steering system includes a steer-by-wire steering system. In some embodiments, the motor is associated with a handwheel actuator of the steering system. In some embodiments, the motor is associated with a roadwheel actuator of the steering system. In some embodiments, calculating the DC bridge voltage includes calculating the bridge voltage based on the inverter feedback regulator outputs. In some embodiments, the modulation index value is configured to control torque harmonic performance of the motor. In some embodiments, calculating the DC bridge voltage includes using feedforward motor equations. In some embodiments, selectively controlling the motor based on the bridge voltage includes either increasing or decreasing the DC bridge voltage with respect to the nominal input battery voltage.

In some embodiments, a system includes a controller configured to: set, for a motor, a modulation index to a predetermined value; calculate a DC bridge voltage based on a predetermined value of the modulation index; and selectively control the motor based on the calculated DC bridge voltage.

In some embodiments, the motor includes a permanent magnet synchronous motor. In some embodiments, the motor is associated with a steering system of a vehicle. In some embodiments, the steering system includes a steer-by-wire steering system. In some embodiments, the motor is associated with a handwheel actuator of the steering system. In some embodiments, the motor is associated with a roadwheel actuator of the steering system. In some embodiments, the controller is further configured to calculate the DC bridge voltage based on the magnitude of the inverter closed-loop PI regulator commands. In some embodiments, the controller is further configured to calculate the DC bridge voltage using feedforward calculations. In some embodiments, the controller is configured to selectively control the motor by either increasing or decreasing the DC bridge voltage with respect to the nominal input battery voltage.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A method comprising:
setting, for a motor, a modulation index to a predetermined value;
calculating a bridge voltage for an output voltage command based on the predetermined value of the modulation index; and
selectively controlling the motor based on the bridge voltage.

2. The method of claim 1, wherein the motor includes a permanent magnet synchronous motor.

3. The method of claim 1, wherein the motor is associated with a steering system of a vehicle.

4. The method of claim 3, wherein the steering system includes a steer-by-wire steering system.

5. The method of claim 4, wherein the motor is associated with a handwheel actuator of the steering system.

6. The method of claim 4, wherein the motor is associated with a roadwheel actuator of the steering system.

7. The method of claim 1, wherein calculating the bridge voltage includes calculating the bridge voltage based on an output voltage magnitude associated with the output voltage command.

8. The method of claim 1, wherein calculating the bridge voltage includes calculating the bridge voltage includes using motor feedforward model equations.

9. The method of claim 1, wherein the modulation index value is configured to control current harmonic performance of the motor.

10. The method of claim 1, wherein selectively controlling the motor based on the bridge voltage includes using at least one voltage reference of the feedforward motor model equations.

11. The method of claim 10, wherein the at least one voltage reference is calculated using the inverter feedback proportional-integral regulator outputs.

12. A system comprising:
a controller configured to:
set, for a motor, a modulation index to a predetermined value;
calculate a bridge voltage for an output voltage command based on the predetermined value of the modulation index; and
selectively control the motor based on the bridge voltage.

13. The system of claim 12, wherein the motor includes a permanent magnet synchronous motor.

14. The system of claim 12, wherein the motor is associated with a steering system of a vehicle.

15. The system of claim 14, wherein the steering system includes a steer-by-wire steering system.

16. The system of claim 15, wherein the motor is associated with a handwheel actuator of the steering system.

17. The system of claim 15, wherein the motor is associated with a roadwheel actuator of the steering system.

18. The system of claim 12, wherein the controller is further configured to calculate the bridge voltage based on an output voltage magnitude associated with the output voltage command.

19. The system of claim 12, wherein the controller is further configured to calculate the bridge voltage using feedforward motor model equations.

20. The system of claim 12, wherein the controller is further configured to selectively control the motor based on the bridge voltage using at least one voltage reference.
